(19) United States
(12) Patent Application Publication
(10) Pub. No.: US 2019/0303805 A1
(43) Pub. Date: Oct. 3, 2019

(54) RIDESHARE RESERVATION SYSTEM, METHOD, AND PROGRAM-STORED MEDIUM

(71) Applicant: TOYOTA JIDOSHA KABUSHIKI KAISHA, Toyota-shi (JP)

(72) Inventors: Atsushi MIZUTANI, Toyota-shi (JP); Yuma SAIKI, Toyota-shi (JP); Momoko AZUMA, Tokyo-to (JP); Yusaku MORITA, Miyoshi-shi (JP); Kanako NARUSE, Toyota-shi (JP)

(73) Assignee: TOYOTA JIDOSHA KABUSHIKI KAISHA, Toyota-shi (JP)

(21) Appl. No.: 16/359,527

(22) Filed: Mar. 20, 2019

(30) Foreign Application Priority Data
Mar. 30, 2018 (JP) 2018-069468

(51) Int. Cl. G06Q 10/02; G06Q 10/08; G06T 7/62; G06T 7/70

(52) U.S. Cl. CPC G06Q 10/02; G06T 7/70; G06T 7/62; G06Q 10/0838

(57) ABSTRACT

A management server and a user terminal include a detection unit, a luggage information identification unit, a matching unit, and an output unit. Luggage identification data employed to identify luggage carried by a rider is input to the user terminal if the rider rideshares a vehicle. By making a rideshare reservation after a loading position of the luggage in the vehicle has been determined if the luggage is loadable therein, the rider is able to load the luggage being carried with reference to information indicating the loading position indicated by the output unit if ridesharing the vehicle.

### CROSS-REFERENCE TO RELATED APPLICATION

This application claims priority under 35 USC 119 from Japanese Patent application No. 2018-069468 filed on Mar. 30, 2018, the disclosure of which is incorporated by reference herein in its entirety.

### BACKGROUND

### Technical Field

The present disclosure relates to a rideshare reservation system, method, and program-stored medium.

### Related Art

Japanese Patent Application Laid-Open (JP-A) No. 2016-194854 describes technology relating to a rideshare support system. In this rideshare support system, a driver driving a household car registers a travel plan. A match is made by the rideshare support system when a rider wishing to ride on the registered travel plan makes a reservation, and the driver and the rider are both notified. This enables ridesharing in vehicles to be achieved simply.

However, with the rideshare support system described in JP-A No. 2016-194854, it is difficult to ascertain in advance the size of loading space available for luggage to be loaded in the planned rideshare vehicle. This lack of knowledge means that delays in loading luggage might be incurred since the efficiency of loading space utilization depends on how the luggage is loaded, and this might be detrimental to convenience when ridesharing.

### SUMMARY

The present disclosure obtains a rideshare reservation system, method, and program-stored medium capable of enhancing convenience when ridesharing.

A rideshare reservation system according to a first aspect of the present disclosure includes a detection unit, a luggage information identification unit, a matching unit, and an output unit. The detection unit is configured to detect luggage identification data employed to identify luggage carried by a user who will ride in a vehicle. The luggage information identification unit is configured to identify at least size information for the luggage based on the luggage identification data. The matching unit is configured to determine whether or not the luggage is loadable in the vehicle based on the size information of the luggage, to decide a loading position of the luggage in the vehicle if the luggage deemed loadable, and to make or not make a reservation for the user to rideshare in the vehicle based on a result of the determination. The output unit is configured to output information indicating whether a rideshare reservation has been made or not made, and to indicate the loading position of the luggage in the vehicle if a rideshare reservation has been made.

According to the first aspect as described above, the rideshare reservation system includes the detection unit, the luggage information identification unit, the matching unit, and the output unit. When a user is going to rideshare in a vehicle, the detection unit detects the luggage identification data employed to identify the luggage carried by the user. The luggage information identification unit identifies at least the size information for the luggage based on the detected luggage identification data. The matching unit then determines whether or not the luggage is loadable in the rideshare candidate vehicle based on the size information of the luggage and determines the loading position of the luggage in the vehicle when deemed loadable. The matching unit also makes or does not make a reservation for the user to rideshare in the vehicle based on the determination result. Thus, by not making a reservation when the luggage is non-loadable, a situation can be avoided in which a user is not able to load the luggage to be carried when ridesharing a vehicle into the rideshare vehicle.

However, when the luggage is deemed loadable, a reservation is made after the loading position of the luggage in the vehicle has been determined. The user is thereby able to load the luggage to be carried by referring to information indicating the loading position displayed on the output unit when ridesharing in the vehicle. Namely, the luggage can be loaded smoothly, and the loading space for luggage in the vehicle can be utilized efficiently due to the matching unit determining loading positions while also considering other luggage and the like.

Reference here to “user” encompasses drivers who drive vehicles, riders ridesharing (riding) in vehicles driven by a driver or autonomous vehicles, and candidate riders who wish to rideshare.

The “luggage identification data” encompasses data such as image data captured of the luggage, voice data and text data indicating the name and size etc. of the luggage, classification data classifying the luggage according to luggage type and size.

A rideshare reservation system according to a second aspect of the present disclosure is the first aspect, wherein after determining that there is a possibility of luggage other than the luggage being loaded on top of the luggage, the matching unit notifies the user of the possibility of the other luggage being loaded on top of the luggage.

According to the second aspect as described above, the matching unit notifies the user of the possibility of luggage other than the luggage being loaded on top of the luggage when determined that there is a possibility of the other luggage being loaded on top of the luggage. The user is accordingly able in advance to select another vehicle or take countermeasures such as wrapping the luggage in cases in which the luggage to be carried is fragile and liable to be affected by the other luggage. This enables damage or the like to the luggage to be prevented.

A rideshare reservation system according to a third aspect of the present disclosure is the first or second aspect, wherein the matching unit decides the loading position of the luggage in the vehicle in consideration of at least one of a user pick-up sequence or a user drop-off sequence if the luggage is deemed loadable.

According to the third aspect as described above, the matching unit determines the loading position of the luggage in the vehicle in consideration of at least one out the user pick-up sequence or the user drop-off sequence when the luggage is deemed loadable. This enables drop-off to be performed smoothly by, as an example, placing the luggage carried by a user having an earlier drop-off in front of the other luggage. Namely, the loading positions of the luggage can be allocated as appropriate according to the pick-up or drop-off status, thereby enabling at least one out of pick-ups or drop-offs to be performed smoothly.

A rideshare reservation system according to a fourth aspect of the present disclosure is the first to the third aspect, wherein the matching unit decides the loading position of the luggage in the vehicle in consideration of a type of the luggage if the luggage is deemed loadable.

According to the fourth aspect as described above, the matching unit decides the loading position of the luggage in the vehicle in consideration of the luggage type when the luggage is deemed loadable. This accordingly enables more luggage to be loaded by loading other luggage on top the luggage in cases in which, for example, the luggage is a hard-shelled suitcase. This accordingly enables the loading space for loading luggage in the vehicle to be used more efficiently.

A rideshare reservation system according to a fifth aspect of the present disclosure is the first to the fourth aspect, wherein the detection unit is a user terminal in possession of the user, and the luggage identification data is image data of the luggage captured using the user terminal.

According to the fifth aspect as described above, the detection unit is a user terminal in possession of the user and the luggage identification data is image data of the luggage captured using the user terminal. The user is thereby able to input the luggage identification data of the luggage easily, wherever they are, without measuring the size of the luggage being carried or the like.

A rideshare reservation system according to a sixth aspect of the present disclosure is the first to the fifth aspect, wherein, in cases in which non-loadable is the determined result from determining whether or not the luggage is loadable in the vehicle based on the size information of the luggage, the matching unit notifies the user of size information of luggage that would be loadable.

According to the sixth aspect as described above, the matching unit notifies the user of size information of luggage that would be loadable when the luggage to be loaded has been determined to be non-loadable in the vehicle. The user is thereby able to consider whether to reorganize the luggage based on the size information of the luggage that would be loadable, or whether to ride in a different vehicle. Namely, the user can be provided with more selections.

A rideshare reservation system according to a seventh aspect of the present disclosure is the first to the sixth aspect, wherein based on the luggage identification data, the luggage information identification unit identifies at least size information of the luggage from a luggage database storing information about plural items of luggage, or from information accessible over a communication network line.

According to the seventh aspect as described above, based on the detected luggage identification data, the luggage information identification unit identifies at least the size information of the luggage from the luggage database stored with information about plural items of luggage, or from information accessible over a communication network line. This makes it easy to acquire more precise size information or the like.

An eighth aspect of the present disclosure is a rideshare reservation method includes detecting luggage identification data employed to identify luggage carried by a user who will ride in a vehicle, identifying at least size information for the luggage based on the luggage identification data, determining whether or not the luggage is loadable in the vehicle based on the size information of the luggage, and deciding a loading position of the luggage in the vehicle if the luggage deemed loadable. The rideshare reservation method also includes deciding to make or not make a reservation for the user to rideshare in the vehicle based on a result of determining whether or not the luggage is loadable in the vehicle, and outputting information indicating whether a rideshare reservation has been made or not made and indicating the loading position of the luggage in the vehicle if a rideshare reservation has been made.

A ninth aspect of the present disclosure is a non-transitory storage medium stored with a rideshare reservation program. The program causes a computer to execute processing including receiving luggage identification data employed to identify luggage carried by a user who will ride in a vehicle, identifying at least size information for the luggage based on the luggage identification data, determining whether or not the luggage is loadable in the vehicle based on the size information of the luggage, and deciding a loading position of the luggage in the vehicle if the luggage deemed loadable. The processing also includes deciding to make or not make a reservation for the user to rideshare in the vehicle based on a result of determining whether or not the luggage is loadable in the vehicle, and transmitting information indicating whether a rideshare reservation has been made or not made and indicating the loading position of the luggage in the vehicle if a rideshare reservation has been made.

The rideshare reservation system, method, and program-stored medium according to the first, eighth, and ninth aspects accordingly enable the convenience when ridesharing to be enhanced.

The rideshare reservation system according to the second to seventh aspects enable the convenience when ridesharing to be enhanced further.

### BRIEF DESCRIPTION OF THE DRAWINGS

Exemplary embodiments of the present disclosure will be described in detail based on the following figures, wherein:

FIG. 1 is a schematic diagram illustrating an outline of a rideshare reservation system according to a first exemplary embodiment;

FIG. 2 is a flowchart schematically illustrating processing during travel plan registration by a driver using a rideshare reservation system according to the first exemplary embodiment;

FIG. 3 is a flowchart schematically illustrating processing during reservation by a rider using a rideshare reservation system according to the first exemplary embodiment;

FIG. 4 is a schematic diagram illustrating an example of luggage identification data input in a rideshare reservation system according to the first exemplary embodiment;

FIG. 5 is a schematic diagram illustrating an example of a screen display on a user terminal during luggage identification data input in a rideshare reservation system according to the first exemplary embodiment;

FIG. 6 is a flowchart schematically illustrating processing when luggage identification data is classification information in a rideshare reservation system according to the first exemplary embodiment;

FIG. 7 is a schematic diagram illustrating a chain of events in a case in which a luggage loading position has been decided in a rideshare reservation system according to the first exemplary embodiment;

FIG. 8 is a schematic diagram illustrating transmitted states of luggage loading positions by a rideshare reservation system according to the first exemplary embodiment; and

FIG. 9 is a flowchart schematically illustrating processing during reservation by a rider using a rideshare reservation system according to a second exemplary embodiment.

### DETAILED DESCRIPTION

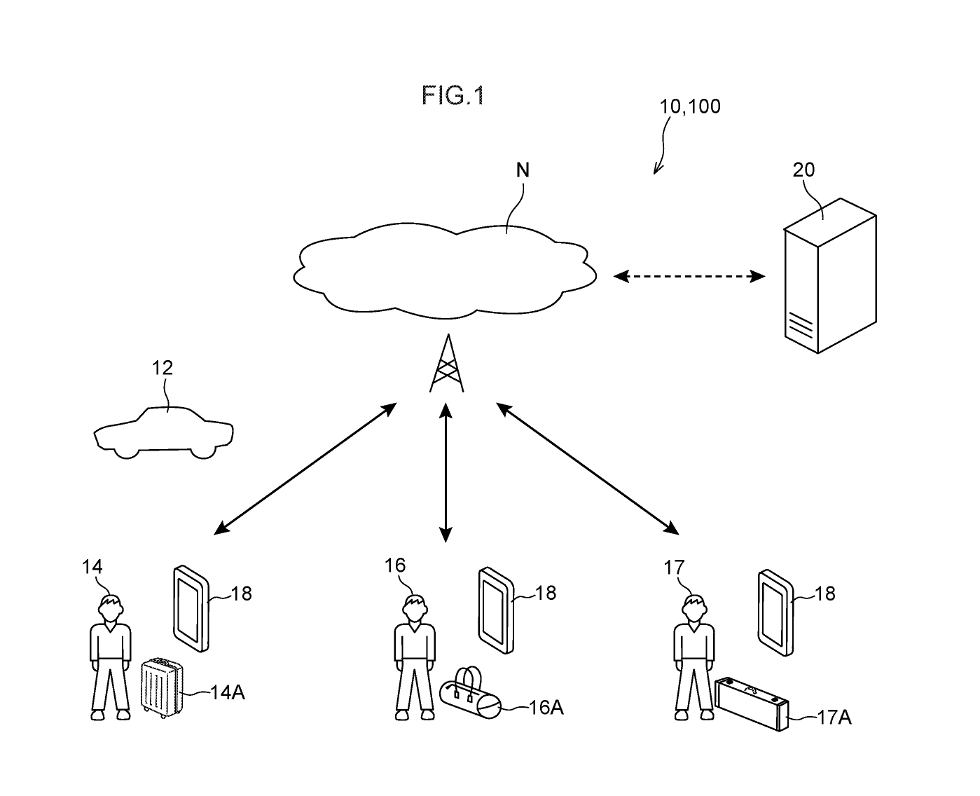

Explanation follows regarding exemplary embodiments of a rideshare reservation system according to the present disclosure, with reference to FIG. 1 to FIG. 8.

Overall Configuration

As illustrated in FIG. 1, a rideshare reservation system 10 of the present exemplary embodiment includes user terminals 18 and a management server 20. The user terminals 18 are terminals in the possession of a driver 14, serving as a user who drives a vehicle 12, and riders 16, 17, serving as users wishing to ride in the vehicle 12, and each user terminal 18 serves as a detection unit and an output unit. The management server 20 serves as a luggage information identification unit and a matching unit. The user terminals 18 in the possession of the riders 16, 17 are capable of accessing the management server 20 over a communications network N configured by a mobile communications service such as 3G or LTE, or the internet, serving as a communication network line. Although the communications network N is configured by a mobile communications service or the internet in the present exemplary embodiment, there is no limitation thereto, and the communications network N may be a closed network that is isolated from public networks.

The user terminals 18 are configured by smartphones, cellular phones, tablet terminals, personal computers, or the like, and each includes a CPU, ROM, RAM, storage, a communication interface, a display device, an input device, an imaging device, a voice input device, and so on (none of these are illustrated). The CPU is a processor that executes programs stored in the storage and performs various computation. The ROM is a non-volatile storage device that stores programs and data employed on startup of the user terminal 18. The RAM is a volatile storage device that functions as a work area when programs are executed by the CPU. The storage is a non-volatile storage device that stores various programs and data, including an operating system (OS) and application programs. The communication interface is an interface that communicates with other devices. In the present exemplary embodiment, the communication interface has a function of performing wireless communication according to various communication protocols. For ease of explanation, in the following explanation, the CPU of each of the user terminals 18 reads a predetermined program stored in the storage and executes the program using the RAM as a work area in order to execute various functions of the user terminal 18. In this sense, the CPU controls the various configurations of the user terminal 18.

The display device is a device that displays information, and includes a liquid crystal display, an organic EL display, or the like. The input device is a device used by the driver 14 or the riders 16, 17 to input instructions and information to their user terminal 18, and includes, for example, at least one out of a touch sensor, a keypad, or buttons. In the present exemplary embodiment, each of the user terminals 18 includes a touchscreen, and the user touches UI images (buttons, icons, and the like) displayed on the display device to input instructions to the user terminal 18. The imaging device includes a visible light camera, and is a device used to capture at least still images. The voice input device includes a microphone, and is a sound-recording device.

The storage stores a program (referred to hereafter as a client application) that causes a computer device to function as a client of the rideshare reservation system 10. The client application operates in coordination with hardware elements and other software elements such as the OS to implement a detection unit on the user terminal 18.

The management server 20 is, for example, a generic computer device, and includes a CPU, ROM, RAM, storage, and a communication interface (none of these are illustrated). The CPU is a processor that executes programs stored in the storage, and performs various computation. The ROM is a non-volatile storage device that stores programs and data employed on startup of the server. The RAM is a volatile storage device that functions as a work area when programs are executed by the CPU. The storage is a non-volatile storage device that stores various programs and data, such as the OS and application programs. The communication interface is an interface that communicates with other devices such as the user terminals 18, and with the communications network N. For ease of explanation, in the following explanation, the CPU of the management server 20 reads a predetermined program stored in the storage and executes the program using the RAM as a work area in order to execute various functions of the management server 20. In this sense, the CPU controls the various configurations of the management server 20.

The storage stores a server program that causes a computer device to function as a server of the rideshare reservation system 10. The CPU executes the server program to implement a luggage information identification unit, a matching unit, and an information output section on the management server 20. The storage also stores databases in which data employed by the rideshare reservation system 10 is recorded. The databases employed by the rideshare reservation system 10 include a user database, a reservation database, and a luggage database.

Operation

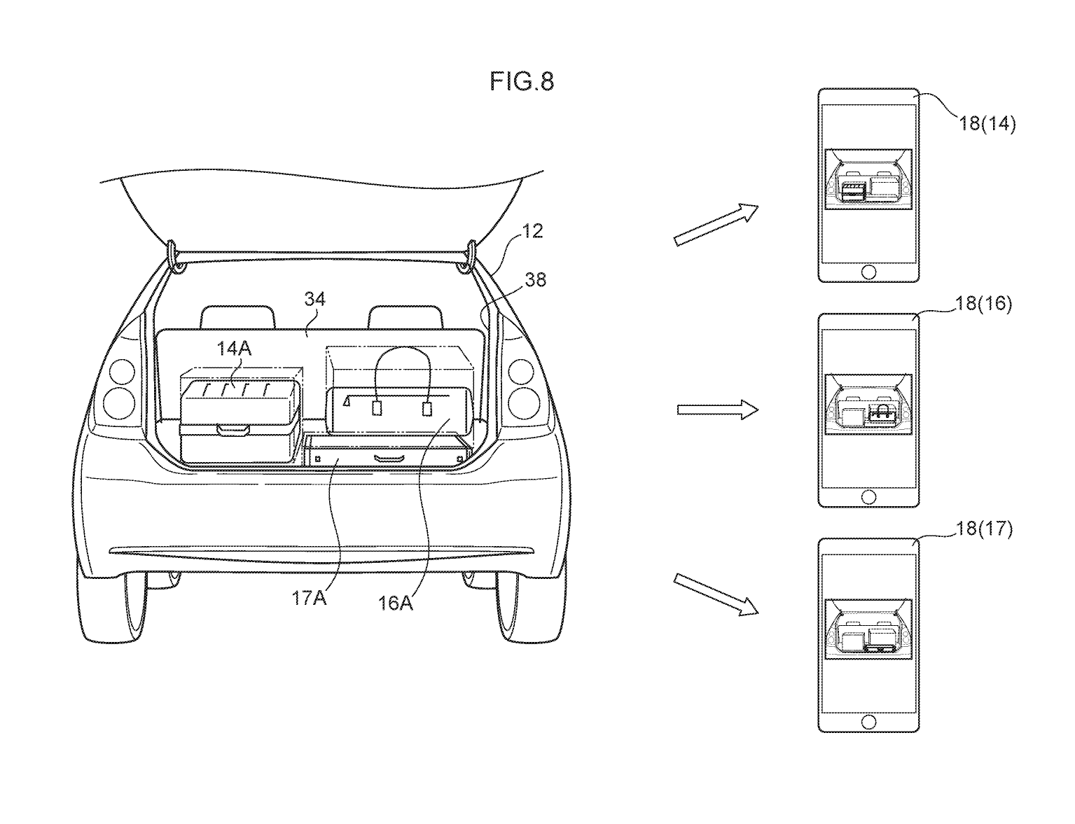

Explanation follows regarding operation of the rideshare reservation system 10. The rideshare reservation system 10 is administered by an organization providing the rideshare reservation system 10. The driver 14 and the riders 16, 17 wishing to take advantage of the rideshare reservation system 10 each perform user registration in advance. During user registration, the driver 14 or the riders 16, 17 input their own profile information (unique information). The profile information includes, for example, a username, a password, gender, age, place of residence, email address, and profile picture. Note that although there are not separate categories in the rideshare reservation system 10 to be used in user registration for the driver 14 and the riders 16, 17, the terms “driver” and “rider” are used herein for ease of explanation. The profile information of the user serving as the driver 14 also includes, for example, information relating to their car, such the model, year, color, a photograph of the exterior, and the luggage loading capacity of a trunk 34 (see FIG. 8) configuring a loading space for luggage. This profile information is recorded in the user database of the management server 20. Specifically, the luggage loading capacity of the vehicle 12 recorded in the user database is recorded using information acquired from the manufacturer of the vehicle 12, information actually measured by the driver 14, or the like.

Driver Registration

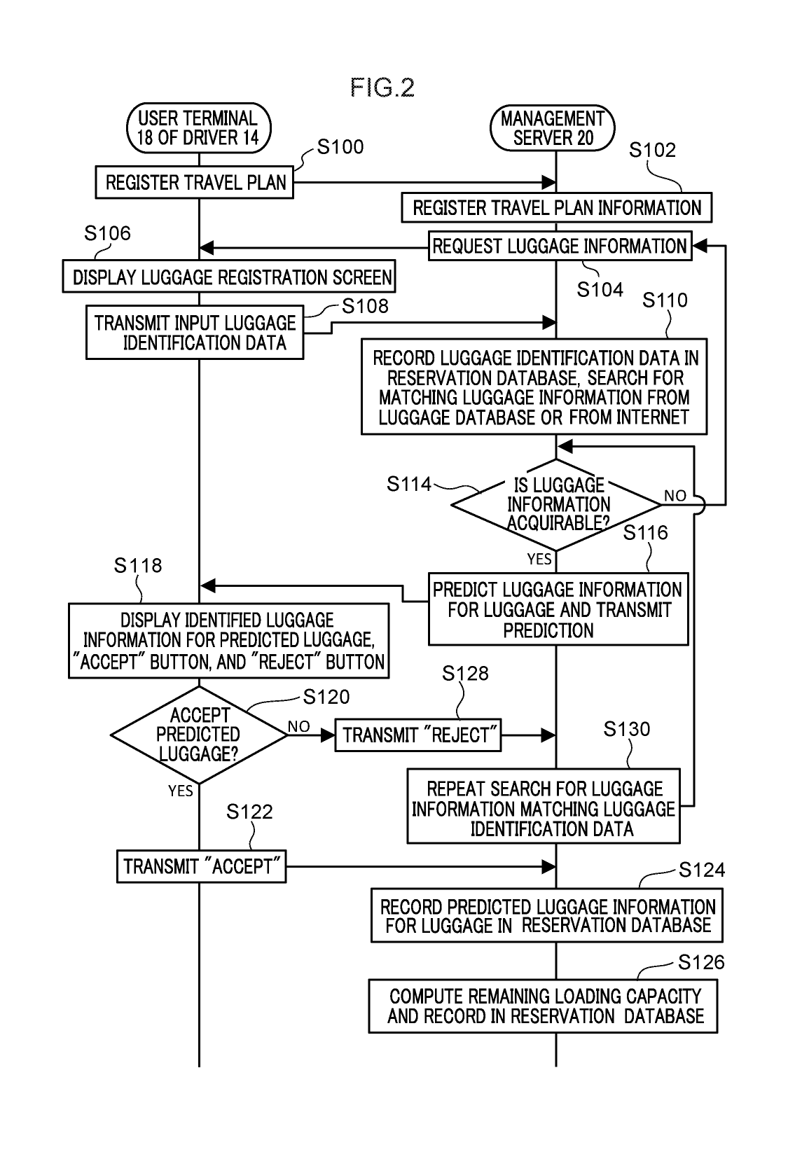

FIG. 2 is a flowchart illustrating a detailed example of processing during travel plan registration by the driver 14 using the rideshare reservation system 10. In rideshare reservation in the present exemplary embodiment, first, the user serving as the driver 14 advertises for users (the riders 16, 17) to rideshare on a particular travel plan. The riders 16, 17 wishing to rideshare then respond to the advertisement.

Using their own user terminal 18, the driver 14 inputs the travel plan to advertise for users wishing to rideshare. After the CPU of the user terminal 18 of the driver 14 receives the input travel plan, the CPU starts the processing illustrated in FIG. 2. A travel plan includes, for example, a departure time, a departure point, a destination point, and a number of possible riders.

At step S100, the CPU of the user terminal 18 of the driver 14 transmits the input travel plan to the management server 20. After the management server 20 receives the travel plan from the user terminal 18, the CPU of the management server 20 starts the processing illustrated in FIG. 2.

At step S102, the CPU of the management server 20 records the travel plan data received from the user terminal 18 of the driver 14 in the reservation database. Next, at step S104, the management server 20 sends a request to input luggage identification data relating to luggage 14A that the driver 14 intends to carry to the user terminal 18 of the driver 14.

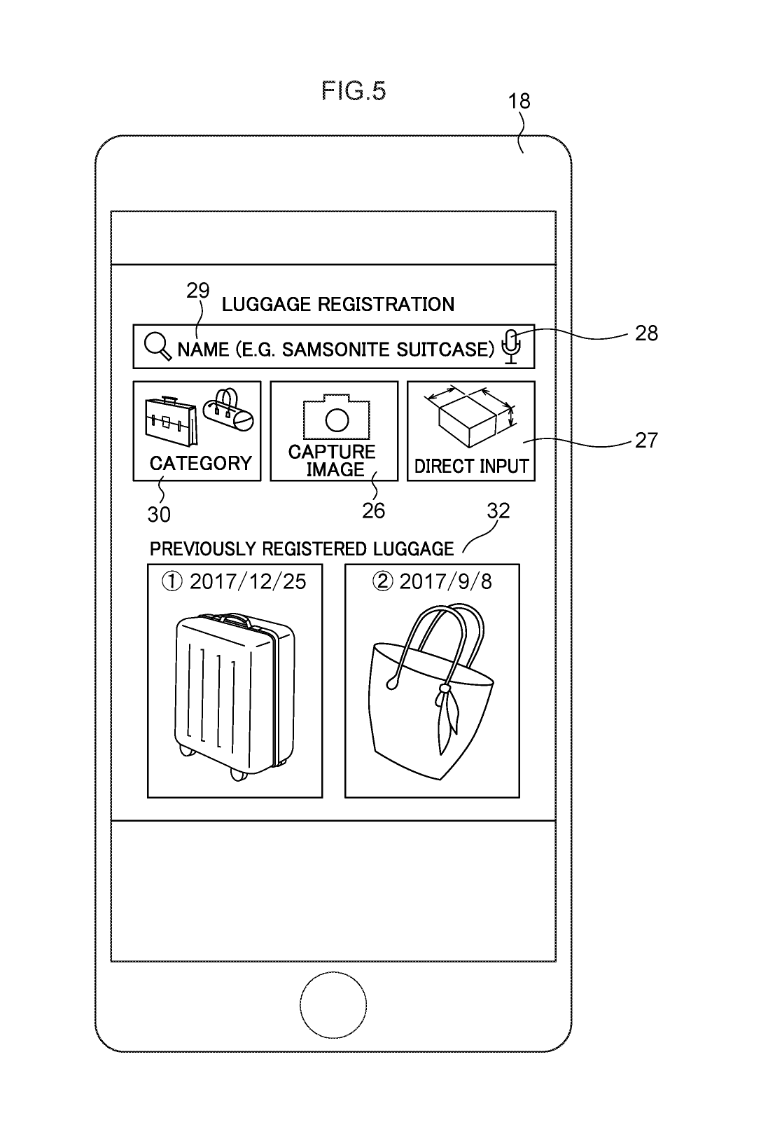

On receipt of the notification for input of luggage identification data from the management server 20, at step S106, as illustrated in FIG. 5, the CPU of the user terminal 18 of the driver 14 displays a luggage registration screen on the display device of the user terminal 18. The driver 14 selects and inputs their desired luggage identification data from out of plural luggage identification data items on the luggage registration screen.

Luggage Identification Data Using Image Data

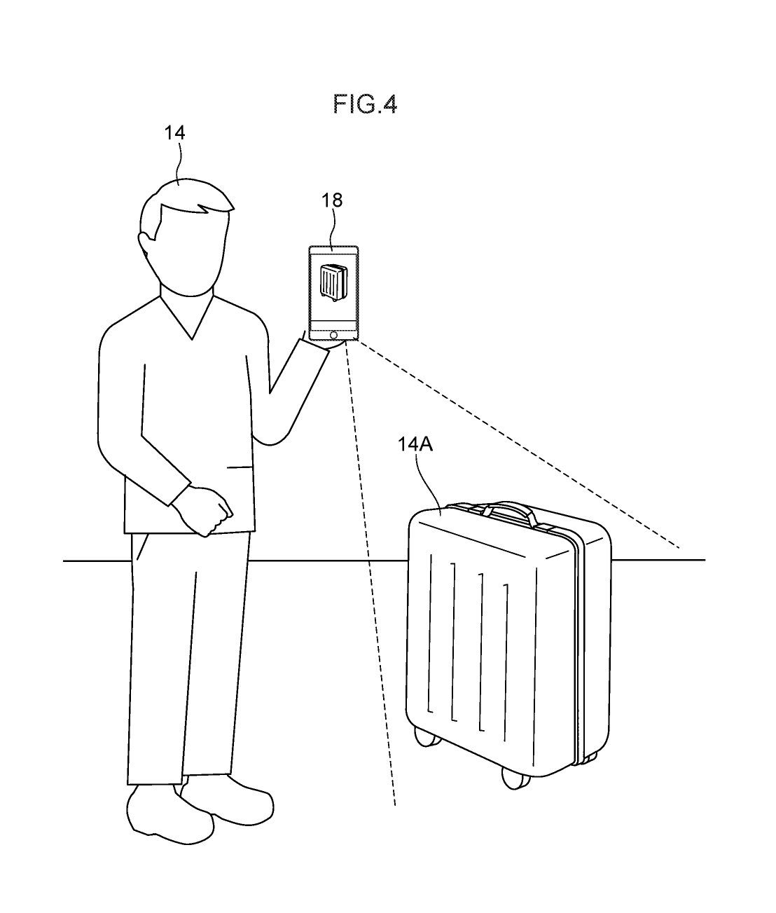

The luggage identification data for the luggage is configured by at least one out of luggage image data, voice data, text data, classification data classified in advance according to luggage type, and the like. The luggage identification data is detected by the user terminal 18. In a case in which image data is employed as the luggage identification data, for example, the driver 14 presses an “image capture” button 26 displayed on the luggage registration screen of the user terminal 18 to start up the imaging device of the user terminal 18 in order to input the luggage identification data. Then, as illustrated in FIG. 4, the luggage 14A that the driver 14 intends to carry is imaged using the user terminal 18, and at step S108, the captured image data is sent from the user terminal 18 to the management server 20, as illustrated in FIG. 2.

At step S110, the CPU of the management server 20 records the image data received from the user terminal 18 in the reservation database, and matches the luggage 14A pictured in the image data against luggage information recorded in the luggage database. For example, a deep learning method is employed for this matching. Deep learning refers to machine learning methods employing multi-tiered neural networks constructed from plural processing layers connected together in a hierarchical structure.

In deep learning, in each tier of the multi-tiered neural network, computation processing is performed on input data of plural different pieces of computation result data obtained by the preceding tier, namely on extraction result data of feature amounts. The feature amount data thus obtained is then subjected to further computation processing in subsequent processing tiers in order to improve the recognition rate of the feature amounts and enable classification of the input data into plural classes.

Such deep learning methods might conceivably be applied to the image data described above to classify each pixel in the image data into plural classes. For example, when classifying the luggage 14A included in the image data, the image data is employed as the input, and neural network deep learning is performed for the luggage 14A to be processed in the image data so as to classify (match) the luggage 14A against plural types of luggage identification recorded in the luggage database. Employing a neural network that has been trained by deep learning in this manner enables the luggage 14A in the input image data to be classified (matched) against the plural types of luggage information. Note that the luggage information includes at least size information from out of size information (for example length dimension, width dimension, and height dimension), volume, external profile, weight, and property information such as “fragile” or “must be kept upright” for the luggage.

If luggage information recorded in the luggage database cannot be found to match the image data from the user terminal 18, the CPU of the management server 20 searches information accessible over the communications network N (see FIG. 1). If luggage matching the image data is found at step S114, the CPU of the management server 20 acquires the luggage information corresponding to this luggage. At step S116 this luggage information is predicted to be the luggage information for the luggage 14A pictured in the image data, and the prediction result is transmitted to the user terminal 18 of the driver 14.

If there is no luggage matching the image data at step S114, the management server 20 returns to step S104 and notifies the user terminal 18 of the driver 14 with a request to repeat input of luggage identification data for the luggage 14A that the driver 14 intends to carry. Note that although not illustrated in the drawings, when notifying to request repeat input of the luggage identification data of the luggage 14A, luggage identification data that is different to that input previously may be requested, or the driver 14 may be requested to measure the dimensions of the luggage 14A and input the measurement results using a “direct input” button 27 (see FIG. 5) on the luggage registration screen. Note that when measuring the dimensions of the luggage 14A for use with the “direct input” button 27, a generic tape measure or the like may of course be employed for measuring, or the driver 14 may, for example, input the specific model or the like of the user terminal 18 they are using, and input the length dimension (or width dimension or height dimension) in terms of “number of lengths” of the user terminal 18, such that the actual dimensions are computed by the management server 20 based on the input result and the results thereof are predicted to be the luggage information for the luggage 14A.

Luggage Identification Data Using Voice Data

In cases in which voice data is employed as the luggage identification data for the luggage, the driver 14 presses a “speak” button 28 (see FIG. 5) displayed on the luggage registration screen on the user terminal 18 to start up the voice input device of the user terminal 18 in order to input the luggage identification data. The driver 14 then speaks the type and name of the luggage to be carried (for example “SAMSONITE (registered trademark) suitcase”). When the driver 14 has finished speaking, at step S108 the CPU of the user terminal 18 sends the obtained spoken voice data to the management server 20. The CPU of the management server 20 analyzes the voice data received from the user terminal 18 and generates text information based on the voice data. At step S110, the voice data and the text information are recorded together in the reservation database. The CPU of the management server 20 then matches the generated text information against the luggage database (or information accessible over the communications network N), and at step S114, if luggage that matches the text information exists, luggage information corresponding to this luggage is acquired. At step S116, this luggage information is predicted to be the luggage information for the luggage 14A indicated by the voice data, and the prediction result is transmitted to the user terminal 18 of the driver 14.

If there is no luggage matching the voice data at step S114, similarly to in the case of image data described above, the management server 20 returns to step S104 and notifies the user terminal 18 of the driver 14 with a request to repeat input of luggage identification data for the luggage 14A that the driver 14 intends to carry.

Luggage Identification Data Using Text Data

In cases in which text data is employed as the luggage identification data for the luggage, the driver 14 inputs the type and name of the luggage to be carried (for example “SAMSONITE (registered trademark) suitcase”) as text in a “search column” 29 (see FIG. 5) displayed on the luggage registration screen of the user terminal 18 in order to input the luggage identification data. The driver 14 then presses a non-illustrated “search” button, and the CPU of the user terminal 18 sends the input text data to the management server 20. At step S110, the CPU of the management server 20 records the text data received from the user terminal 18 in the reservation database, and matches the text data against the luggage database (or information accessible over the communications network N), and at step S114 acquires luggage information corresponding to this luggage if luggage that matches the text data exists. At step S116, this luggage information is predicted to be the luggage information for the luggage 14A indicated by the text data, and the prediction result is transmitted to the user terminal 18 of the driver 14.

If there is no luggage matching the text data at step S114, similarly to in the case of image data described above, the management server 20 returns to step S104 and notifies the user terminal 18 of the driver 14 with a request to repeat input of luggage identification data for the luggage 14A that the driver 14 intends to carry.

Luggage Identification Data Using Classification Data

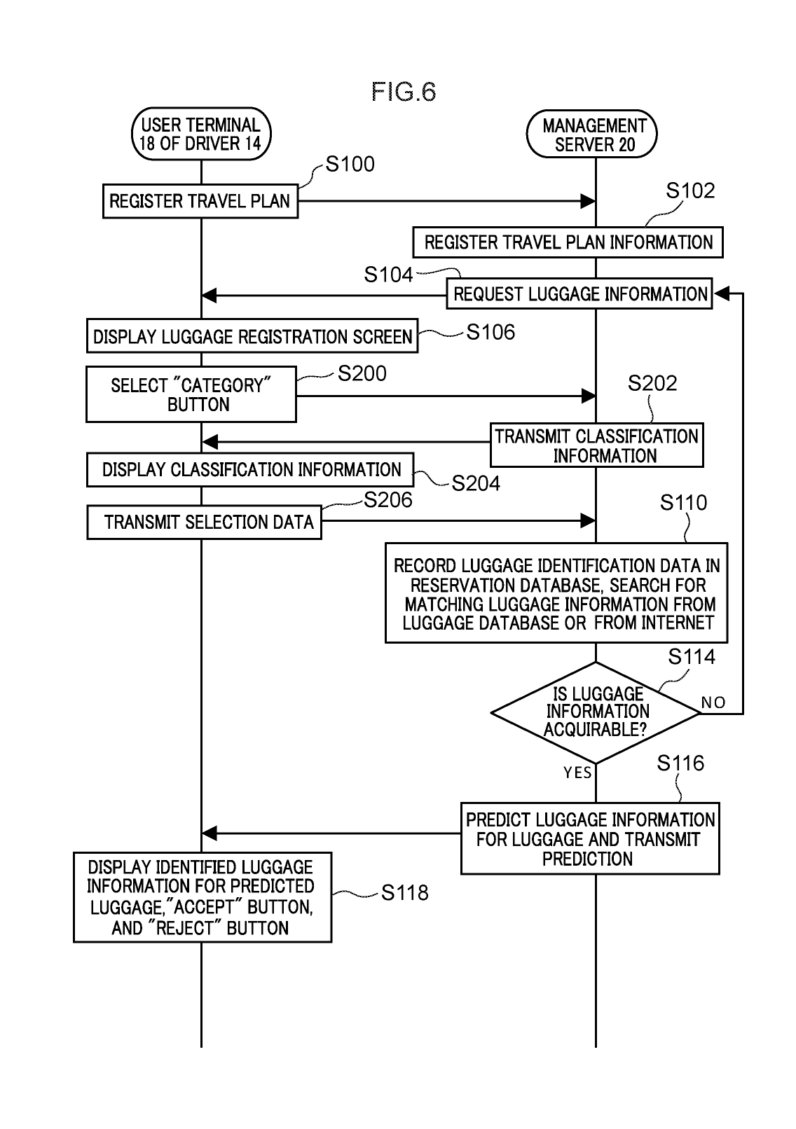

In cases in which classification data is employed as the luggage identification data for the luggage, the driver 14 presses a “category” button 30 (see FIG. 5) displayed on the luggage registration screen on the user terminal 18 in order to input the luggage identification data. When the “category” button 30 is pressed, as illustrated in FIG. 6, at step S200, the CPU of the user terminal 18 notifies the management server 20 that the “category” button 30 has been pressed. On receipt of the notification that the “category” button 30 has been pressed from the user terminal 18, at step S202, the CPU of the management server 20 responds to the user terminal 18 with classification information classified by type, such as suitcase or Boston bag, size, etc. At step S204, the CPU of the user terminal 18 displays the classification information received from the management server 20 on the display device, and prompts the driver 14 to select the classification information corresponding to the luggage 14A to be carried. At step S206, the user terminal 18 then transmits the selected data to the management server 20. At step S110 illustrated in FIG. 2, the CPU of the management server 20 records the classification information received from the user terminal 18 in the reservation database, and matches the classification information against the luggage database (or information accessible over the communications network N), and at step S114, if luggage matching the classification information exists, luggage information corresponding to this luggage is acquired. At step S116, this luggage information is predicted to be the luggage information for the luggage 14A indicated by the classification information, and the prediction result is transmitted to the user terminal 18 of the driver 14.

If there is no luggage matching the classification information at step S114, similarly to in the case of image data described above, the management server 20 returns to step S104 and notifies the user terminal 18 of the driver 14 with a request to repeat input of luggage identification data for the luggage 14A that the driver 14 intends to carry.

Luggage Information Registration

As illustrated in FIG. 2, at step S118, the CPU of the user terminal 18 of the driver 14 displays on the display device an “accept” button and a “reject” button (neither of these are illustrated) for the prediction result received from the management server 20 regarding the luggage 14A. The driver 14 press-operates the “accept” button if the prediction result for the luggage 14A is basically correct. If the “accept” button is pressed at step S120, the CPU of the user terminal 18 of the driver 14 transmits acceptance notification to the management server 20 at step S122. At step S124, the CPU of the management server 20 records the luggage information including at least the size information of the luggage 14A in the reservation database and the user database, and at step S126, the CPU of the management server 20 computes a remaining loading capacity by subtracting the size, volume or the like of the luggage 14A from the luggage loading capacity of the vehicle 12 recorded in the user database, and records the result of this computation in the reservation database. Note that from the next time the driver 14 inputs luggage identification data for the luggage 14A, the luggage information for the luggage 14A of the driver 14 already recorded in the user database is displayed so as to be selectable in a “previously registered luggage” column 32 (see FIG. 5) on the luggage registration screen. When this is performed, the date of ride, ride segment, and the like may also be displayed alongside the input image data.

However, in cases in which the prediction result for the luggage 14A displayed at step S118 is not correct, at step S120, the driver 14 press-operates the “reject” button. If the “reject” button is pressed, the CPU of the user terminal 18 of the driver 14 transmits rejection notification to the management server 20 at step S128. At step S130, the CPU of the management server 20 repeats the search of the luggage database or of information accessible over the communications network N to find luggage matching the luggage identification data of the luggage 14A. If luggage matching the luggage identification data exists, at step S114, luggage information corresponding to this luggage is acquired, and at step S116, this luggage information is predicted to be the luggage information for the luggage 14A, and the prediction result is transmitted to the user terminal 18 of the driver 14 as a second candidate. If there is no luggage that matches the luggage identification data at step S114, the management server 20 returns to step S104 and notifies the user terminal 18 of the driver 14 with a request to repeat input of the luggage identification data for the luggage 14A that the driver 14 intends to carry. The above processing is repeated until notification that the “accept” button has been pressed has been received. Note that although not illustrated in the drawings, the management server 20 may notify the user terminal 18 of the driver 14 to input different luggage identification data (for example, the result of the driver measuring the luggage size directly) when the “reject” button has been pressed.

Rider Registration

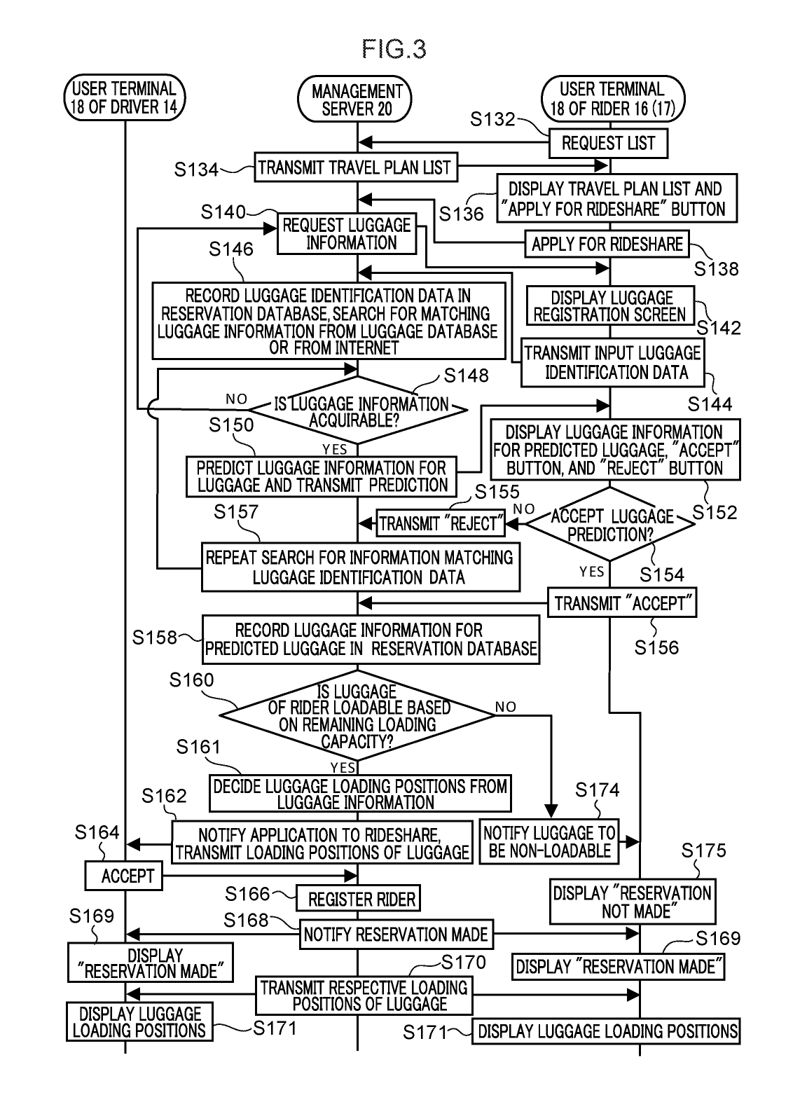

The rider 16 (17) wishing to rideshare on one of the plural travel plans registered on the reservation database inputs this desire using a non-illustrated display screen on their user terminal 18. On receipt of the input travel plan, the CPU of the user terminal 18 of the rider 16 (17) starts the processing illustrated in FIG. 3. As illustrated in FIG. 3, at step S132, the CPU of the user terminal 18 of the rider 16 (17) transmits a travel plan list transmission request to the management server 20 in response to an instruction from the rider 16 (17). This transmission request includes selection-narrowing conditions to narrow down the plural travel plans registered on the reservation database for display. Note that as an example in the present exemplary embodiment, the riders 16, 17 (see FIG. 1) serve as two ridesharing users. The following explanation focuses mainly on the rider 16, but basically the same applies for the rider 17.

At step S134, the CPU of the management server 20 extracts travel plans from the reservation database plans appropriate to the selection-narrowing conditions included in the transmission request received from the user terminal 18 of the rider 16 (17). The CPU of the management server 20 transmits data representing a list of extracted travel plans to the user terminal 18 of the rider 16 (17) that sent the transmission request.

At step S136, the CPU of the user terminal 18 of the rider 16 (17) displays the travel plan list data received from the management server 20 on the display device together with an “apply for rideshare” button and input columns in which to input a desired pick-up location and drop-off location (none of these are illustrated). The rider 16 (17) press-operates the “apply for rideshare” button if they wish to reserve a rideshare on a particular travel plan being displayed. When the “apply for rideshare” button is pressed, at step S138, the CPU of the user terminal 18 of the rider 16 (17) transmits notification of this to the management server 20. At step S140, the management server 20 sends the user terminal 18 of the rider 16 (17) a request to input luggage identification data for luggage 16A (17A) to be carried by the rider 16 (17) (see FIG. 4).

At step S142, on receipt of the notification to input luggage identification data for the luggage 16A (17A) from the management server 20, as illustrated in FIG. 5, the CPU of the user terminal 18 of the rider 16 (17) displays a luggage registration screen on the display device. The rider 16 (17) inputs one type of luggage identification data, similarly to in the case of the driver 14 described above. In the present exemplary embodiment, as illustrated in FIG. 4, the rider 16 (17) uses the user terminal 18 to capture an image of the luggage 16A (17A) to be carried, and at step S144 in FIG. 3, the image data obtained by this image capture is sent from the user terminal 18 to the management server 20. Note that in the present exemplary embodiment, the rider 16 (17) inputs image data as the luggage identification data. However, there is no limitation thereto, and of course voice data, text data, classification information, directly measured dimensions, and the like may be applied as the luggage identification data as described above.

At step S146, the CPU of the management server 20 records the image data received from the user terminal 18 in the reservation database using a method similar to that in the case of the driver 14, described above. The CPU of the management server 20 matches the image data against the luggage database (or information accessible over the communications network N), and at step S148, acquires luggage information for this luggage if luggage matching the image data exists. At step S150, this luggage information is predicted to be the luggage information for the luggage 16A (17A) indicated by the image data, and the prediction result is transmitted to the user terminal 18 of the rider 16 (17).

Note that the matching performed at step S146 may employ the deep learning method described above with reference to step S110.

At step S152, the CPU of the user terminal 18 of the rider 16 (17) displays the prediction result for the luggage 16A (17A) of the rider 16 (17) received from the management server 20 on the display device together with an “accept” button and a “reject” button (neither of these are illustrated). At step S154, the rider 16 (17) press-operates the “reject” button if the prediction result for the luggage 16A (17A) is not correct. If the “reject” button is pressed, at step S155, the CPU of the user terminal 18 of the rider 16 (17) transmits rejection notification to the management server 20. At step S157, the CPU of the management server 20 performs matching of the image data against the luggage database (or information accessible over the communications network N) again, and processing proceeds as at step S148 described above.

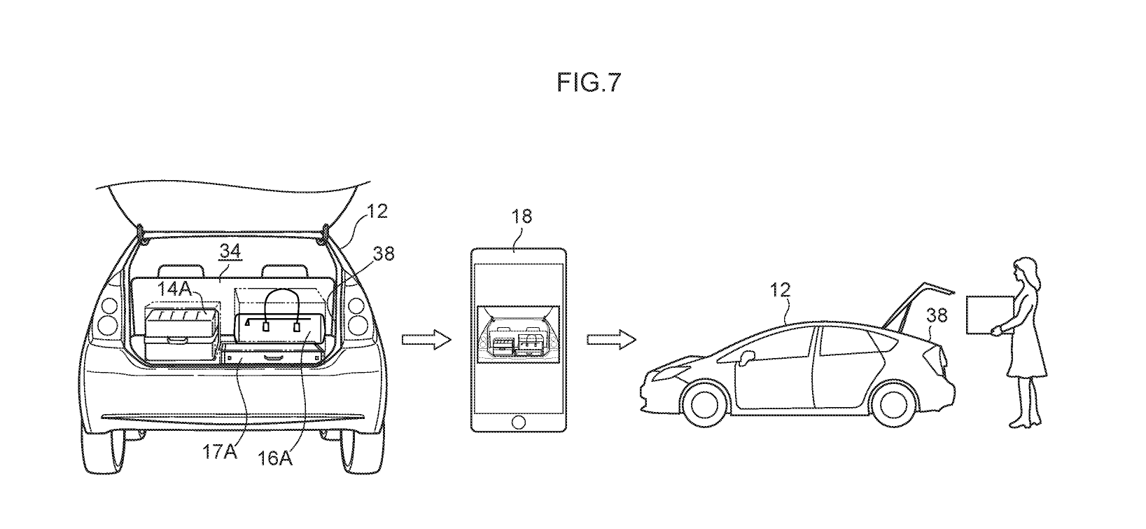

At step S154, the rider 16 (17) press-operates the “accept” button if the prediction result for the luggage 16A (17A) is basically correct. If the “accept” button is pressed, the CPU of the user terminal 18 of the rider 16 (17) transmits acceptance notification to the management server 20 at step S156. At step S158, the CPU of the management server 20 records the luggage information such as the size information of the luggage 16A (17A) in the reservation database. In this manner, luggage information is accumulated in the luggage database. At step S160, the CPU of the management server 20 determines whether or not the luggage 16A is loadable in the remaining loading capacity registered in the reservation database. At step S161, loading positions of the luggage 14A of the driver 14 and the luggage 16A (17A) of the rider 16 (17) in the trunk 34 are decided (see FIG. 7) when the luggage 16A of the rider 16 is deemed loadable. The loading positions are decided from the luggage information for the luggage 14A and the luggage 16A (17A) by computing loading positions that enable space in the trunk 34 to be used efficiently.

Note that at step S161, in cases in which, for example, based on the luggage information the luggage 14A of the driver 14 is registered as being made of a hard material with a property of not being easily damaged, such as a hard-shelled suitcase for example, the CPU of the management server 20 decides loading positions (not illustrated in the drawings) which might include loading other luggage (the luggage 16A, 17A in the present exemplary embodiment) on top of the luggage 14A. When this is performed, in cases in which the other luggage 16A, 17A is to be loaded on top of the luggage 14A, at step S162, described later, the owner of the luggage 14A (i.e. the driver 14) may be notified that the other luggage 16A, 17A will be loaded on top.

At step S161, in cases in which there are plural ridesharing users (riders 16, 17) and at least one out of the pick-up location or the drop-off location differs between the respective riders 16, 17, the CPU of the management server 20 decides the loading positions of the luggage 14A, 16A, 17A in consideration of at least one out of the pick-up sequence or the drop-off sequence. As an example, in cases in which one rider 17 is to be dropped off earlier than another rider 16, the loading positions are decided such that the luggage 17A carried by the rider 17 who is to be dropped off earlier is loaded on an opening 38 side (near side, see FIG. 8) of the trunk 34. This facilitates unloading of the luggage 17A when dropping off the rider 17 having the earlier drop-off. There is no limitation thereto, and the loading positions of the luggage 14A, 16A, 17A may be decided in consideration of only the pick-up sequence, or the loading positions of the luggage 14A, 16A, 17A may be decided in consideration of both the pick-up sequence and the drop-off sequence.

After deciding the loading positions of the luggage 14A of the driver 14 and the luggage 16A, 17A of the riders 16, 17 in the trunk 34, at step S162, the CPU of the management server 20 transmits application notification, information regarding the rider 16 (17), information regarding the luggage 16A (17A) to be carried by the rider 16 (17), and the loading positions of the luggage 14A, 16A (17A) etc. to the user terminal 18 of the driver 14. When transmitting the loading positions of the luggage 14A, 16A (17A), the CPU of the management server 20 uses the luggage information to create a simple 3D model corresponding to the luggage 14A, 16A (17A), and transmits the 3D model and a graphic representing boxes configured by wireframes schematically representing the spaces allocated to the respective luggage 14A, 16A (17A) in a state loaded into the trunk 34 at the respective loading positions (see FIG. 7). If the luggage 16A (17A) of the rider 16 (17) is deemed non-loadable, at step S174 the user terminal 18 of the rider 16 (17) is notified that the luggage 16A is non-loadable, and the fact that the reservation was not made is displayed on the display device (step S175).

On receipt of the application notification and the like from the management server 20, the CPU of the user terminal 18 of the driver 14 displays on the display device the information regarding the rider 16 (17), the information regarding the luggage 16A (17A) to be carried by the rider 16 (17), the graphic of the loading positions for the luggage 14A, 16A (17A), an “accept” button, and a “reject” button (none of these are illustrated). If the driver 14 presses the “accept” button, at step S164 the CPU of the user terminal 18 of the driver 14 transmits acceptance notification to the management server 20.

On receipt of acceptance notification from the user terminal 18 of the driver 14, at step S166, the CPU of the management server 20 registers the rider 16 (17), the luggage 16A (17A) to be carried by the rider 16 (17), and the loading positions for the luggage 14A, 16A (17A) in a database as rider registration against the corresponding travel plan. Moreover, the CPU of the management server 20 reduces the available seats on this travel plan by one. If the number of available seats on this travel plan becomes zero, the CPU of the management server 20 switches ON a “full” flag for this travel plan. When the “full” flag has been switched ON, the travel plan is no longer eligible for extraction in response to list transmission requests.

At step S168, the CPU of the management server 20 notifies the user terminal 18 of the driver 14 and the user terminal 18 of the rider 16 (17) that a match (reservation) has been made. On receipt of the notification that a match has been made, the CPU of the user terminal 18 of the driver 14 and the CPU of the user terminal 18 of the rider 16 (17) each display that a reservation has been made on the respective display devices (step S169). At step S170, the CPU of the management server 20 transmits the loading positions of the luggage 14A, 16A (17A) to the user terminal 18 of the driver 14 and to the user terminal 18 of the rider 16 (17). In order to transmit the loading positions, similarly to at step S162, the CPU of the management server 20 creates a simple 3D model and boxes configured by wireframes corresponding to the luggage 14A, 16A (17A), and transmits a graphic illustrating the 3D model and loaded states of the boxes loaded into the loading positions in the trunk 34. When this is performed, as illustrated in FIG. 8, a graphic emphasizing the loading position of the luggage 14A is transmitted to the user terminal 18 of the driver 14 owning the luggage 14A, and a graphic emphasizing the loading position of the luggage 16A (17A) is transmitted to the user terminal 18 of the rider 16 (17) owning the luggage 16A (17A). On receipt of the graphics of the loading positions, the CPU of the user terminal 18 of the driver 14 and the CPU of the user terminal 18 of the rider 16 (17) display the graphics transmitted from the management server 20 on their respective display devices (step S171). The rideshare reservation is completed by the above processing.

### Operation of the Present Exemplary Embodiment

Explanation follows regarding operation of the present exemplary embodiment.

In the present exemplary embodiment, the rideshare reservation system 10 includes the management server 20 and the user terminals 18 illustrated in FIG. 1, the detection unit, the luggage information identification unit, the matching unit, and the output unit. When the rider 16 (17) wishes to rideshare in the vehicle 12, the rider 16 (17) inputs the user terminal 18 with the luggage identification data employed to identify the luggage 16A (17A) carried by the rider 16 (17). Based on the input luggage identification data, the management server 20 identifies at least the size information for the luggage 16A from the luggage database stored with information about plural items of luggage, or from information accessible over a communications network N. Then based on the size information for the luggage 16A (17A), the management server 20 determines whether or not the luggage 16A (17A) is loadable into the rideshare candidate vehicle 12. The luggage 16A (17A) being deemed loadable is taken as one condition for making a reservation for a rideshare in the vehicle. Conversely, the luggage 16A (17A) being deemed non-loadable is taken as one condition for not making a reservation for a rideshare in the vehicle. Namely, the rider 16 (17) is able to reserve a ride-shareable vehicle 12 in which the luggage 16A (17A) to be carried is loadable. This enables a situation to be avoided in which the rider 16 (17) when ridesharing the vehicle 12 is then unable to load the luggage 16A (17A) being carried into the rideshare vehicle 12. This thereby enables the convenience when ridesharing to be enhanced.

When the luggage 16A (17A) is deemed loadable, the reservation is made once the loading position of the luggage 16A (17A) in the vehicle 12 has been determined. When ridesharing in the vehicle 12, the rider 16 (17) is able to load the luggage 16A (17A) to be carried by referring to information illustrating the loading positions indicated on the output unit (see FIG. 7). Namely, the luggage 16A (17A) can be loaded smoothly, and the trunk 34 (see FIG. 7) of the vehicle 12 can also be utilized efficiently due to the management server 20 determining loading positions by also considering the other luggage 14A and the like.

The management server 20 stores the luggage 14A, 16A (17A) for which the size information has been identified by storing in association with the driver 14 or the rider 16 (17) who will carry the luggage 14A, 16A (17A). The luggage 14A, 16A (17A) stored associated with the driver 14 or the rider 16 (17) in the management server 20 is made selectable the next time the driver 14 or the rider 16 (17) inputs the detection unit with the luggage identification data for the luggage 14A, 16A (17A) to be carried. Accordingly, the driver 14 or the rider 16 (17) is able to input the luggage identification data for the luggage 14A, 16A (17A) easily the next time they ride carrying any of the luggage 14A, 16A (17A) the same as the luggage 14A, 16A (17A) previously carried when riding.

The user terminals 18 in the possession of the driver 14 or the rider 16 (17) are employed when inputting the luggage identification data, and the luggage identification data is configured by image data of the luggage 14A, 16A (17A) captured using the user terminals 18. The driver 14 or the rider 16 (17) is accordingly able to input the luggage identification data for the luggage 14A, 16A (17A) easily wherever they are, without measuring the size or the like of the luggage 14A, 16A (17A) to be carried. This enables convenience when ridesharing to be further enhanced.

In cases in which the management server 20 has determined there to be a possibility of loading at least one other item of luggage 14A, 16A, 17A on top of at least one item of luggage 14A, 16A, 17A, the management server 20 notifies the user (driver 14, riders 16, 17) carrying the luggage 14A, 16A, 17A of the possibility that the other item of luggage 14A, 16A, 17A might be loaded on top. Accordingly, the user (driver 14, riders 16, 17) is able in advance to select another vehicle 12 or to take countermeasures such as wrapping the luggage 14A, 16A, 17A in cases in which the luggage 14A, 16A, 17A to be carried is fragile or the like and liable to be affected by the other item of luggage 14A, 16A, 17A. This enables damage or the like to the luggage 14A, 16A, 17A to be prevented.

The loadability of luggage 16A (17A) of the rider 16 (17) is determined in a state in which the luggage information for the luggage 14A carried by the driver 14 has been subtracted from the loading capacity of the vehicle in advance. Namely, employing a more precise loading capacity as a parameter enables loading of the luggage 16A (17A) to be performed smoothly when ridesharing. This thereby enables convenience when ridesharing to be even further enhanced.

When the luggage 16A, 17A deemed loadable, the management server 20 determines the loading positions of the luggage 14A, 16A, 17A in the vehicle 12 in consideration of at least one out of the pick-up sequence or the drop-off sequence of the riders 16, 17. Accordingly, the drop-off can be performed smoothly by, for example, placing the luggage 17A carried by the rider 17 with an earlier drop-off in front of the other luggage. Namely, the loading positions of the luggage 14A, 16A, 17A can be allocated as appropriate according to the pick-up or drop-off status, thereby enabling at least one out of pick-ups or drop-offs to be performed smoothly.

Moreover, the management server 20 determines the loading position of the luggage 14A in the trunk 34 of the vehicle 12 in consideration of the type of the luggage 14A when deemed loadable. Accordingly, more luggage can be loaded by, as an example, loading the other luggage 16A, 17A on top of the luggage 14A when the luggage 14A is a hard-shelled suitcase. This thereby enables the trunk 34 of the vehicle 12 to be utilized more efficiently.

### Second Exemplary Embodiment

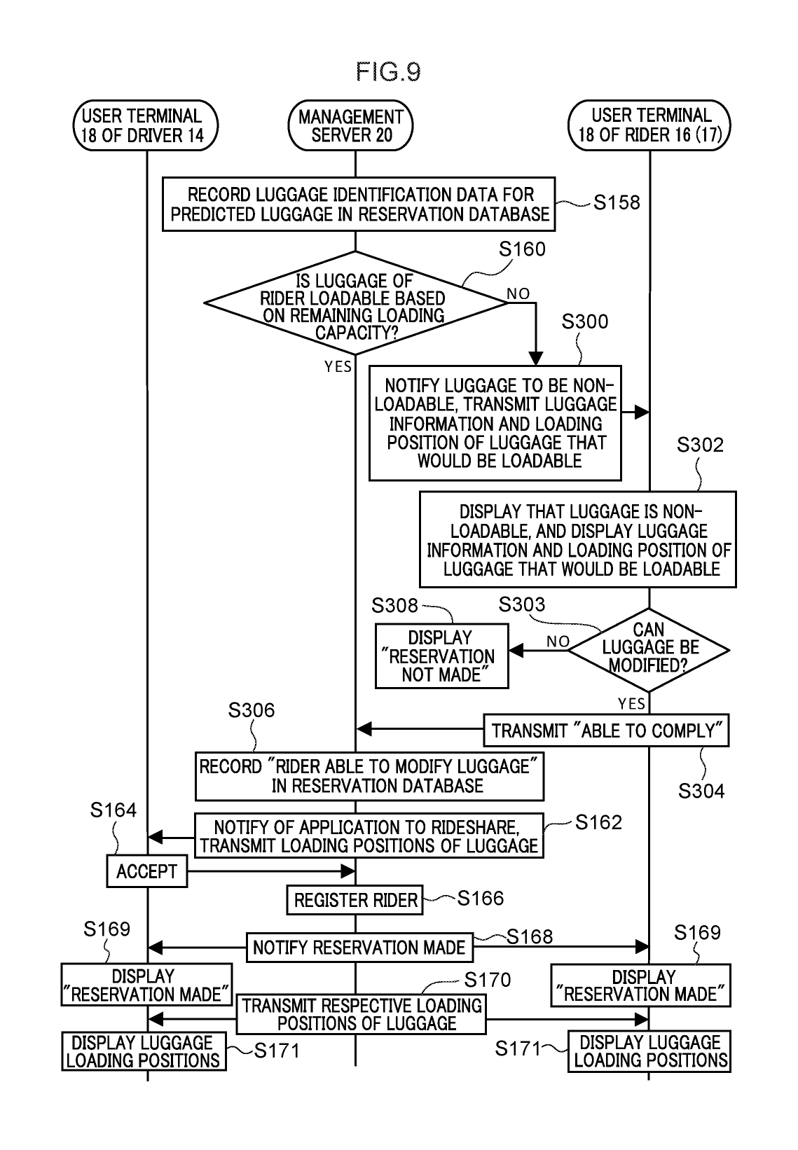

Explanation follows regarding a rideshare reservation system according to a second exemplary embodiment of the present disclosure, with reference to FIG. 9. Portions similar in configuration to those of the first exemplary embodiment described above are allocated the same reference numerals, and explanation thereof is omitted.

A rideshare reservation system 100 according to the second exemplary embodiment has the same basic configuration as its counterpart in the first exemplary embodiment, and includes a feature of notifying information regarding luggage that would be loadable when notifying that the luggage 16A (17A) of a rider 16 (17) is non-loadable in the vehicle 12.

Namely, as illustrated in FIG. 9, at step S158, the CPU of the management server 20 records luggage information such as the size information of the luggage 16A (17A) in the reservation database, and at step S160, the CPU of the management server 20 determines whether or not the luggage 16A (17A) is loadable for the remaining loading capacity registered in the reservation database. When the luggage 16A (17A) of the rider 16 (17) is deemed non-loadable, at step S300 the CPU of the management server 20 notifies the user terminal 18 of the rider 16 (17) that the luggage 16A (17A) is non-loadable. When doing so, the CPU of the management server 20 also notifies information regarding the shape and size of luggage that would be loadable in the vehicle 12 for the remaining loading capacity recorded in the reservation database, as well as information regarding a loading position of the luggage that would be loadable.

At step S302, the user terminal 18 of the rider 16 (17) displays on the display device that the luggage 16A (17A) is non-loadable as well as the size, shape, and loading position of the luggage that would be loadable (none of this is illustrated). If the rider 16 (17) is able to make the luggage 16A (17A) a loadable size, shape, etc. by reorganizing or changing the luggage 16A (17A) or the like based on the indicated loading position, the rider 16 (17) press-operates a “able to comply” button (not illustrated in the drawings). When the “able to comply” button has been pressed at step S303, at step S304 the CPU of the user terminal 18 of the rider 16 (17) transmits notification of ability to comply to the management server 20.

At step S306, the CPU of the management server 20 records in the reservation database the fact that the rider 16 (17) will change the luggage 16A (17A) so as to achieve luggage loadable in the vehicle 12. Next, at step S162 the CPU of the management server 20 transmits to the user terminal 18 of the driver 14 notification of an application to rideshare, the information regarding the rider 16 (17), the fact that the rider 16 (17) will change the luggage 16A (17A) to be carried to luggage loadable in the vehicle 12, the information regarding the loading position, and the like. If the driver 14 accepts this application to rideshare then processing similar to that of the first exemplary embodiment is performed, and the CPU of the user terminal 18 of the driver 14 and the CPU of the user terminal 18 of the rider 16 (17) are caused to display that a reservation has been made on their respective display devices (step S169).

If, however, the rider 16 (17) is unable to make the luggage 16A (17A) a loadable size, shape, etc., the rider 16 (17) press-operates a “not able to comply” button (not illustrated in the drawings). When the “not able to comply” button has been pressed at step S303, the display device is caused to display that the reservation has not been made at step S308.

### Operation of the Second Exemplary Embodiment

Explanation follows regarding operation of the second exemplary embodiment.

The configuration described above is configured similarly to the rideshare reservation system 10 of the first exemplary embodiment, with the exception of the point that information of luggage that would be loadable is also notified when notifying that the luggage 16A (17A) of the rider 16 (17) is non-loadable in the vehicle 12. Accordingly, similar operation to that of the first exemplary embodiment is obtained. Moreover, the management server 20 notifies the rider 16 (17) of size information and a loading position for luggage that would be loadable when the luggage 16A (17A) to be loaded is determined to be non-loadable in the vehicle 12. This enables the rider 16 (17) to consider whether to reorganize or change the luggage 16A (17A) based on the size information of luggage that would be loadable in consideration of the loading position, or whether to ride in a different vehicle. Namely, the rider 16 (17) can be provided with more selections. This thereby enables the convenience to be even further enhanced when ridesharing.

Note that the first and second exemplary embodiments described above are configured such that luggage identification data is detected by the user terminal 18 by the luggage identification data being input to the user terminal 18. However, there is no limitation thereto, and configuration may be made such that luggage identification data is detected by: inputting the luggage identification data using an imaging device installed in a building, an electric vehicle charging station, a vehicle, or the like, using a luggage detection device equipped with a voice input device, a text input device, or the like, or using another dedicated terminal; receiving the luggage identification data with at least one out of the user terminal 18, the luggage detection device, or the other dedicated terminal acting as a reception section; and the driver 14 or the rider 16 (17) confirming the received luggage identification data. Alternatively, plural containers of different sizes may be provided in advance, which size container the luggage fits into checked, and the size information for the container that the luggage fits into detected as the luggage identification data. The luggage identification data may also be detected using another configuration.

There is no limitation to configuring the detection unit from the user terminal 18 or from a sensor employed for image data, voice data, or text input. For example, such sensors or the user terminal 18 may be employed as an external terminal, and the detection unit may be configured by a signal receiver device (for example a signal receiver device provided inside the user terminal 18 or the management server 20) that receives the luggage identification data therefrom.

The luggage information against which the detected luggage identification data is matched is acquired from the luggage database or the communications network N by the management server 20. However, there is no limitation thereto, and other configurations may be applied. For example, a luggage information identification unit may be configured by the CPU or the like of the user terminal 18. If a luggage database recorded with plural pieces of luggage information is held in the user terminal 18, a configuration may be adopted in which the luggage information is acquired without communicating over the communications network N.

Moreover, there is no limitation to a configuration in which luggage information is acquired from the luggage database or over the communications network N to match against the detected luggage identification data. The luggage information may be identified by detecting the size information directly. For example, the size information of the luggage may be predicted from the results of image processing on the image data acquired by the imaging device of the user terminal 18 (this processing may employ known image processing technology).

Although a configuration is adopted in which notifications and information from the management server 20 are displayed on the display device of the user terminal 18, there is no limitation thereto, and such notifications and information may be output to the driver 14 or the rider 16 (17) as audio from a speaker. Alternatively, a configuration may be adopted in which notifications and information are output from a terminal or device other than the user terminal 18, for example a display device or a speaker of a device installed as a car navigation device in the vehicle 12, at an electric vehicle charging station, or in a building.

The output unit is not limited to being a display device or speaker, and may be a transmission device (for example, a signal transmission device provided inside the user terminal 18 or the management server 20) to transmit an output signal that causes images, audio, or the like to be output on a display device, speaker, or the like.

Moreover, although the rideshare reservation system 10, 100 are illustrated as being configurations operated for the purpose of allowing the rider 16 (17) to rideshare in the vehicle 12 driven by the driver 14, there is no limitation thereto. The rideshare reservation system 10, 100 may be operated for the purpose of allowing the rider 16 (17) to rideshare in an autonomous vehicle in which the driver 14 is not present. In such cases, the user corresponding to the driver 14 in the above explanation also becomes a rider 16.

Although a user serving as the driver 14 advertises to recruit a rider 16 (17) to rideshare on a particular travel plan, and a reservation is made by the rider 16 (17) wishing to rideshare on the particular travel plan responding, there is no limitation thereto. A configuration may be adopted in which a rider 16 (17) first registers a desired rideshare date and time, a desired rideshare segment, and luggage identification data. The management server 20 then notifies the rider 16 (17) of information regarding applicable vehicles, and a reservation is made the rider 16 (17) accepts this information.

Moreover, although the management server 20 uses the size information to determine whether or not it is possible to load the luggage 14A, 16A (17A) based on the remaining loading capacity of the vehicle 12, there is no limitation thereto. For example, property information, shape, or weight of luggage may be employed as parameters so as to determine loadabilty such as “other luggage cannot be placed on top of luggage when the luggage is fragile, so no further luggage can be loaded”.

Furthermore, although rideshare reservation is performed by the management server 20 serving as a matching unit, there is no limitation thereto. A configuration may be adopted including plural servers, terminals, and the like, and distributed ledger technology exhibited by a blockchain is employed to hold travel plan information, luggage identification data, and the like on each of the plural servers, terminals, and the like, with a user making a reservation from data on the blockchain that has assured integrity. Other configurations may also be adopted.

Although the CPU of the management server 20 employs a deep learning method to match the luggage 14A pictured in the image data received from the user terminal 18 against the luggage information recorded in the luggage database, there is no limitation thereto. A configuration may be adopted in which the luggage is identified and matched in captured images using another known method such as employing a support vector machine (SVM), template matching, or the like.

Although explanation has been given regarding exemplary embodiments of the present disclosure, the present disclosure is not limited to the above, and obviously various other modifications may be implemented within a range not departing from the spirit of the present disclosure.

What is claimed is:

1. A rideshare reservation system comprising a first device and a second device connected to each other over a network, the first device and the second device each including:
memory; and
a processor coupled to the memory,
the processor of the first device being configured to:
detect luggage identification data employed to identify luggage carried by a user who will ride in a vehicle and transmit the luggage identification data to the second device, and
display information indicating a loading position of the luggage received from the second device on a display, and
the processor of the second device being configured to:
identify at least size information for the luggage based on the luggage identification data received from the first device,
determine whether or not the luggage is loadable in the vehicle based on the size information of the luggage and decide a loading position of the luggage in the vehicle if the luggage deemed loadable,
decide to make or not make a reservation for the user to rideshare in the vehicle based on a result of determining whether or not the luggage is loadable in the vehicle, and
transmit to the first device information indicating whether a rideshare reservation has been made or not made and indicating the loading position of the luggage in the vehicle if a rideshare reservation has been made.

2. The rideshare reservation system of claim 1, wherein the processor of the second device is further configured to notify the user of the possibility of the other luggage being loaded on top of the luggage, after determining that there is a possibility of luggage other than the luggage being loaded on top of the luggage.

3. The rideshare reservation system of claim 1, wherein the processor of the second device decides the loading position of the luggage in the vehicle in consideration of at least one of a user pick-up sequence or a user drop-off sequence if the luggage is deemed loadable.

4. The rideshare reservation system of claim 1, wherein the processor of the second device decides the loading position of the luggage in the vehicle in consideration of a type of the luggage if the luggage is deemed loadable.

5. The rideshare reservation system of claim 1, wherein:
the first device is further configured to serve as a user terminal in possession of the user; and
the luggage identification data is image data of the luggage captured using the user terminal.

6. The rideshare reservation system of claim 1, wherein, in cases in which non-loadable is the determined result from determining whether or not the luggage is loadable in the vehicle based on the size information of the luggage, the processor of the second device notifies the user of size information of luggage that would be loadable.

7. The rideshare reservation system of claim 1, wherein, based on the luggage identification data, the processor of the second device identifies at least size information of the luggage from a luggage database storing information about a plurality of items of luggage, or from information accessible over the network.

8. A rideshare reservation method comprising:
detecting luggage identification data employed to identify luggage carried by a user who will ride in a vehicle;
identifying at least size information for the luggage based on the luggage identification data;
determining whether or not the luggage is loadable in the vehicle based on the size information of the luggage, and deciding a loading position of the luggage in the vehicle if the luggage deemed loadable;
deciding to make or not make a reservation for the user to rideshare in the vehicle based on a result of determining whether or not the luggage is loadable in the vehicle; and
outputting information indicating whether a rideshare reservation has been made or not made and indicating the loading position of the luggage in the vehicle if a rideshare reservation has been made.

9. A non-transitory storage medium stored with a rideshare reservation program, the program causing a computer to execute processing comprising:
receiving luggage identification data employed to identify luggage carried by a user who will ride in a vehicle;
identifying at least size information for the luggage based on the luggage identification data;
determining whether or not the luggage is loadable in the vehicle based on the size information of the luggage, and deciding a loading position of the luggage in the vehicle if the luggage deemed loadable;
deciding to make or not make a reservation for the user to rideshare in the vehicle based on a result of determining whether or not the luggage is loadable in the vehicle; and
transmitting information indicating whether a rideshare reservation has been made or not made and indicating the loading position of the luggage in the vehicle if a rideshare reservation has been made.
